(19) United States
(12) Patent Application Publication
(10) Pub. No.: US 2010/0254303 A1
(43) Pub. Date: Oct. 7, 2010

(54) WIRELESS INTERMEDIARY DEVICE AND WIRELESS TRANSMISSION METHOD

(75) Inventors: Jei Way Hsue, Taipei (TW); Chang Yi Shen, Taipei (TW); Ten Long Dan, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: ASUSTEK COMPUTER INC., Taipei (TW)

(21) Appl. No.: 12/755,158

(22) Filed: Apr. 6, 2010

(30) Foreign Application Priority Data
Apr. 7, 2009 (TW) 098111503

(51) Int. Cl. H04B 7/14

(52) U.S. Cl. 370/315

(57) ABSTRACT

The invention provides a wireless intermediary device and a wireless transmission method. The wireless intermediary device includes a processing module and a plurality of transmission interfaces. Each transmission interface is used for transmitting the data units by a corresponding transmission media frequency, respectively. The processing module distributes the data units to the transmission interfaces according to a distribution principle to transmit the data units. The wireless intermediary device and the wireless transmission method utilize a plurality of wireless systems to increase the available bandwidth. Consequently, the transmission speed is higher, the transmission distance is longer, and multi-layer service application and high quality multimedia stream are provided.

### BACKGROUND OF THE INVENTION

1. Field of the Invention

The invention relates to a wireless intermediary device and a wireless transmission method and, more particularly, to a wireless intermediary device and wireless transmission method utilizing a plurality of wireless systems to increase the bandwidth.

2. Description of the Prior Art

Conventionally, network data is transmitted by packet, and contending between various kinds of data packets for limited bandwidth occurs when being transmitted. If the bandwidth of the network is enough for data throughput, the transmission of the packets is not affected. However, if the throughout of the data packet exceeds a permitted bandwidth load of the network, the network may be crowded, which is like a serious traffic jam caused by various kinds of cars contending for a lane on a road. If various kinds of cars are driven in their distributed lanes, even a motorcycle lane is crowded with motorcycles, buses and cars can be smoothly driven on their lane. A concept for managing the bandwidth is similar to the concept of lane distribution, and that is, to ensure an enough bandwidth for important application programs when the network is crowded.

With the population of the Internet, not only companies have a quickly raised demand for outward network transmission, but also common families or common small office/home office (SOHO) users have increasing dependence upon the internet information sharing. This leads to a high load to the network.

However, the bandwidth of the Internet is high-costly and limited, and cannot be willfully increased with the requirement of users. So, effectively distributing the limited bandwidth resource by the management technology seems to the way to solve the above problem. However, bandwidth managing devices provided for distributing the bandwidth resource is usually in high cost. Otherwise, users must have certain extended network knowledge to correctly set and use the bandwidth managing device. To an enterprise-class router with a bandwidth management function, relating parameters of the router must be set before usage. For example, a class name, a bandwidth budget, a priority are set in a class configuration, and a destination IP address, a destination subnet mask, a destination port, a source IP address, a source subnet mask, a source port, and a protocol ID are set in a filter configuration. These settings are performed by using a web user interface or the telnet. Even abovementioned setting parameters and the setting ways are easy to web managers in companies, however, they are complicated and time-consuming for common home users and SOHO users.

Moreover, the router with the bandwidth management function usually utilizes a one-layer setting way to set the bandwidth. That is, a certain user, a certain application, and a certain bandwidth are set at a time. The setting steps must be repeated if another user, another application, and another bandwidth need to be set. If the bandwidth needs to be set according to the priority of the users and distributed according to the executed applications, the above setting way has low efficiency. Additionally, it is hard for the family user or the SOHO user to find a bandwidth management device which is cheap and easy to operate when they need the bandwidth management.

Additionally, typical 802.11n products may achieve 144 Mbps throughput by utilizing the orthogonal frequency division multiplexing (OFDM) technology, a 2×2 antenna configuration, and the 20 MHz channel width (which means 2.4G frequency band). It may achieve 300 Mbps throughput by utilizing the OFDM, a 2×2 antenna configuration, and the 40 MHz channel width (which means 5G frequency band). It may achieve 450 Mbps throughput if multiple input multiple output (MIMO) is realized via 3×3 antenna configuration. It may achieve 600 Mbps throughput with a 4×4 antenna configuration and a 40 MHz channel width. Even a plurality of groups of antennas may be used to increase the throughput, the network transmission is performed only with one channel width in a conventional method. Therefore, the multi-media application of the wireless bandwidth easily reaches a bottleneck.

Therefore, the invention provides a wireless intermediary device and a wireless transmission method, which utilize a plurality of wireless systems to increase the available bandwidth. Consequently, the transmission speed is enhanced, the transmission distance is longer, and multi-layer service application and multimedia stream with high quality are provided.

### SUMMARY OF THE INVENTION

According to an aspect of the invention, a wireless intermediary device is provided. The wireless intermediary device is mainly used for transmitting a plurality of data units.

The wireless intermediary device according to the invention mainly includes a processing module and a plurality of transmission interfaces. The transmission interfaces are electrically connected with the processing module, respectively. Furthermore, the transmission interfaces may be used for transmitting the data units with the transmission media frequencies, respectively. The processing module may distribute the data units to the transmission interfaces according to a distribution principle to transmit the data units.

According to another aspect of the invention, the wireless transmission method is provided. The wireless transmission system may be used for transmitting a plurality of data units between a first host and a second host via a first wireless intermediary device and a second wireless intermediary device. The first wireless intermediary device includes a plurality of first transmission interfaces, and the second wireless intermediary device includes a plurality of second transmission interfaces.

The wireless transmission method according to the invention mainly includes the following steps. First, the data units are distributed to the first transmission interfaces according to a distribution principle. Second, the data units are transmitted via the first transmission interfaces by corresponding transmission media frequencies, respectively. Third, the data units are received via the second transmission interface, and each second transmission interface corresponds to one of the transmission media frequencies.

With such, the wireless intermediary device and the wireless transmission method according to the invention utilize a plurality of wireless systems to increase the available bandwidth. Consequently, the transmission speed is higher, the transmission distance is longer, and multi-layer service application and high quality multimedia stream are provided.

These and other features, aspects and advantages of the present invention will become better understood with regard to the following description, appended claims, and accompanying drawings.

### BRIEF DESCRIPTION OF THE APPENDED DRAWINGS

FIG. 1 is a schematic diagram showing wireless intermediary devices applied to a wireless transmission system according to a first preferred embodiment of the invention;

FIG. 2 is a flow chart showing a wireless transmission method according to the first preferred embodiment of the invention; and

FIG. 3 is a flow chart showing a wireless transmission method according to a second preferred embodiment of the invention.

### DETAILED DESCRIPTION OF THE INVENTION

The invention provides a wireless intermediary device and a wireless transmission method. The wireless intermediary device and the wireless transmission method utilize a plurality of wireless systems to increase available bandwidth. Consequently, the transmission speed is higher, the transmission distance is longer, and multi-layer service application and high quality multimedia stream are provided. Preferred embodiments are detailly illustrated hereinafter to explain features, concepts, advantages, and convenience of the invention.

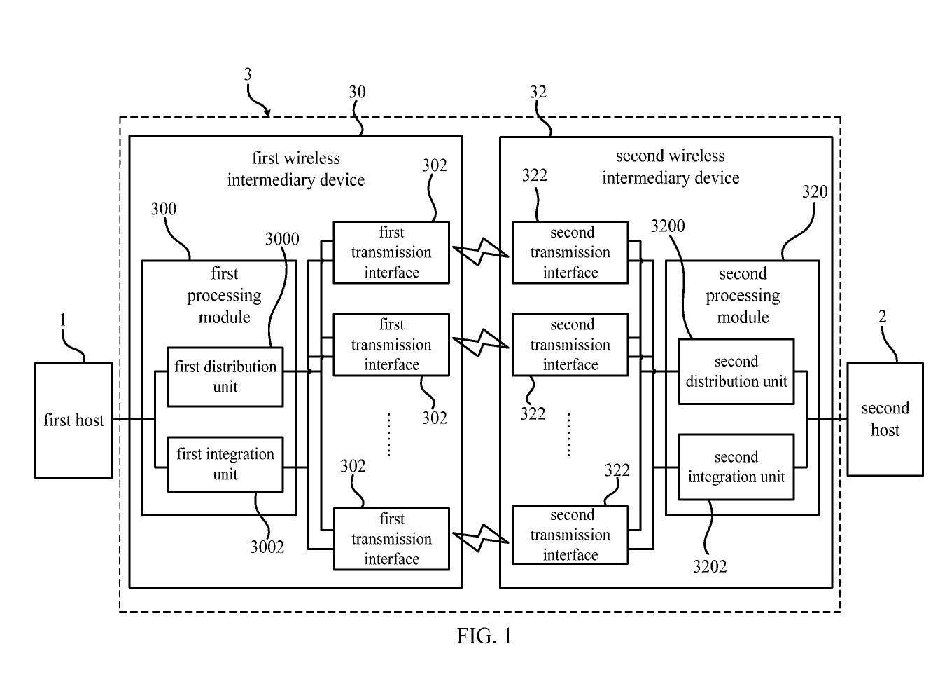

FIG. 1 is a schematic diagram showing wireless intermediary devices (that is, a first wireless intermediary device 30 and a second wireless intermediary device 32) applied to a wireless transmission system 3 according to a preferred embodiment of the invention. As shown in FIG. 1, the wireless transmission system 3 according to an embodiment of the invention may be utilized to transmit a plurality of data units between a first host 1 and a second host. The wireless transmission system 3 mainly includes the wireless intermediary device 30 and the second wireless intermediary device 32. Deep introduction and detailed illustration relating to the structure, a function, and an actuation mode of each part of the wireless transmission system 3 according to an embodiment of the invention are shown hereinafter.

As shown in FIG. 1, the first wireless intermediary device 30 is electrically connected with a first host 1. The first wireless intermediary device 30 may be connected with the first host 1 directly via an electric wire, but the invention is not limited thereto. For example, the first wireless intermediary device 30 and the first host 1 may transmit information to each other via Ethernet. The first wireless intermediary device 30 includes a first processing module 300 and a plurality of first transmission interfaces 302. Each first transmission interface 302 is electrically connected with the first processing module 300. Each first transmission interface 302 may correspond to a transmission media frequency and transmit the data units by the transmission media frequency. Preferably, the transmission media frequency may be orderly distributed at regular intervals, but the invention is not limited thereto. In other words, the transmission media frequencies may be distributed at arithmetic intervals, geometric proportion intervals, or at one of any other intervals. For example, the transmission media frequencies may be divided on a 2.4G frequency band and a 5G frequency band.

In FIG. 1, in an embodiment of the invention, the first processing module 300 of the first wireless intermediary device 30 may further include a first distribution unit 3000. The first distribution unit 3000 is electrically connected with all first transmission interfaces 302, respectively. The first distribution unit 3000 may be used for distributing each data unit to one of the first transmission interfaces 302 according to a distribution principle. In other words, each data unit can be transmitted via only one of the first transmission interfaces 302, which belongs to one-to-one communication.

The distribution principle for distributing each data unit to one of the first transmission interfaces 302 may be a polling manner. That is, averagely distributes the data units to the first transmission interfaces 302. For example, after the data units are distributed according to the above distribution principle, each first transmission interface 302 may transmit at least two distributed data units. The number of actually distributed the data units is mainly determined according to the total efficiency.

Additionally, the distribution principle for distributing each data unit to one of the first transmission interfaces 302 may be a dynamical distribution principle. That is, a loading of all transmission interfaces are dynamically detected, and the data units are dynamically distributed to the first transmission interfaces 302 according to the loading of all the transmission interfaces. For example, when it is detected that the loading of a certain first transmission interface 302 exceeds 75 percent of a maximum loading, the next data unit is automatically distributed to another first transmission interface 302 whose loading does not exceed 75 percent of the maximum loading to be transmitted. For the dynamical distributing way, the determining criterion is not limited to 75 percent of the maximum loading, and it may be flexibly changed according to practical applications or design requirements.

Additionally, the distribution principle for distributing each data unit to one of the first transmission interfaces 302 may be an application specific distribution principle. That is, an application executed in the first host 1 may determine the first transmission interface 302 especially for transmitting the data units generated from the application. For example, the data units of voice-over-internet protocol (VOIP) are distributed to one of the first transmission interfaces 302, and the data units of video stream are distributed to another first transmission interface 302.

In this embodiment, the second wireless intermediary device 32 is electrically connected with the second host 2. The second wireless intermediary device 32 mainly includes a second processing module 32 and a plurality of second transmission interfaces 322. Each second transmission interface 322 is electrically connected with a second processing module 320, respectively. Each second transmission interface 322 corresponds to one of the transmission media frequencies. In other words, each first transmission interface 302 may transmit the data units to a corresponding second transmission interface 322 by a corresponding transmission media frequency. Consequently, when the data units are transmitted via the first transmission interfaces 302 by the corresponding transmission media frequencies, respectively, the second transmission interfaces 322 corresponding to the transmission media frequencies receive the data units immediately, and then the received data units are processed by the second processing module 320. Finally, the data units may be quickly transmitted to the second host 2 from the first host 1.

The above way for transmitting the data units is mainly used when the sizes (such as several KB) of the data units are not too large. As a result, the higher transmission speed may be obtained via the architecture of the wireless transmission system 3 cooperating with the distribution principle of the data units.

In another embodiment, the architecture of the wireless transmission system 3 in FIG. 1 is also taken as an example, and the first processing module 300 of the first wireless intermediary device 30 also may include the first distribution unit 3000. The first distribution unit 3000 is electrically connected with all first transmission interfaces 302, respectively. Furthermore, in this embodiment, the first distribution unit 3000 may be used for dividing the data units and distributing the divided data units to the first transmission interfaces 302 according to the distribution principle. In other words, one data unit may be divided into several parts, and the divided data unit may be transmitted via multiple first transmission interfaces 302, which belongs to multipoint-to-multipoint communication way.

The distribution principle for distributing the divided data units to the first transmission interfaces 302 also may be the polling manner, the dynamical distribution principle, or the application specific distribution as stated above, which is not described herein for a concise purpose.

In this embodiment, as shown in FIG. 1, the second wireless intermediary device 32 is electrically connected with the second host 2. Similarly, the second wireless intermediary device 32 mainly includes the second processing module 320 and a plurality of second transmission interfaces 322. Each second transmission interface 322 is electrically connected with the second processing module 320, respectively. Each second transmission interface 322 corresponds to one of the transmission media frequencies. In other words, each first transmission interface 302 may transmit the data units to a corresponding second transmission interface 322 by a corresponding transmission media frequency.

Moreover, as shown in FIG. 1, the second processing module 320 may further include a second integration unit 3202. The second integration unit 3202 is electrically connected with all second transmission interfaces 322, respectively. Furthermore, the second integration unit 3202 may be used for integrating the divided and received data units to obtain original data units.

Consequently, when the divided data units are transmitted via the first transmission interfaces 302 by corresponding transmission media frequencies, respectively, the second transmission interfaces 322 corresponding to the transmission media frequencies, respectively, receive the data units immediately, and the received data units are integrated by the second integration unit 3202 of the second processing module 320 to obtain the original data units. Finally, the data unit may be immediately transmitted to the second host 2 from the first host 1.

The above way for transmitting the data units is mainly used when the sizes (such as one more than 1 GB) of the data units are large. As a result, the higher transmission speed may be obtained via the architecture of the wireless transmission system 3 cooperating with the distribution principle of the data units.

Additionally, the second wireless intermediary device 32 also may transmit the data units to the first wireless intermediary device 30. That is, the second processing module 320 of the second wireless intermediary device 32 may further include a second distribution unit 3200. The second distribution unit 3200 is electrically connected with all second transmission interfaces 322, respectively. Furthermore, the first distribution unit 3000 may be used for distributing the data units to the first transmission interfaces 302 according to the distribution principle as stated in the above two embodiments, which is not described herein for a concise purpose. Afterwards, the distributed and/or divided data units may be transmitted to corresponding first transmission interfaces 302 via the second transmission interfaces 322.

Comparatively, as shown in FIG. 1, the first processing module 300 may further include the first integration unit 3002. The first integration unit 3002 is electrically connected with all first transmission interfaces 302, respectively. Furthermore, the first integration unit 3002 may be used for integrating the distributed and/or divided data units to obtain the original data units.

The first wireless intermediary device 30 and the second wireless intermediary device 32 may be wireless access points or routers. Furthermore, the first transmission interfaces 302 and the second transmission interfaces 322 may be wireless network cards.

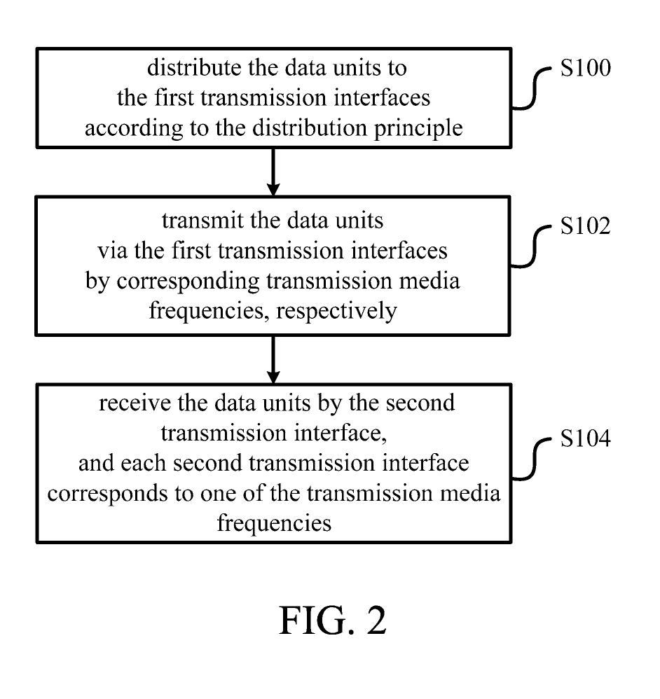

FIG. 2 is a flow chart showing a wireless transmission method according to a first preferred embodiment of the invention. As shown in FIG. 2, the wireless transmission method according to an embodiment of the invention is mainly used for transmitting the data units between the first host and the second host via the first wireless intermediary device and the second wireless intermediary device. The first wireless intermediary device includes a plurality of first transmission interfaces, and the second wireless intermediary device includes a plurality of second transmission interfaces. The wireless transmission method according to an embodiment of the invention may cooperate with the wireless transmission system 3 in FIG. 1 to be used. The detailed architecture of the wireless transmission system 3 is clearly illustrated above, and it is not described herein for a concise purpose. The wireless transmission method according to a first preferred embodiment of the invention mainly includes the following steps.

First, at step S100, the data units are distributed to the first transmission interfaces 302 according to a distribution principle. Afterwards, at step S102, the data units are transmitted via the first transmission interfaces 302 by corresponding transmission media frequencies, respectively. Finally, at step S104, the data units are received by the second transmission interface 322, and each second transmission interface 322 corresponds to one of the transmission media frequencies.

The wireless transmission method according to the first preferred embodiment of the invention may be used when the sizes of the data units are not too large, and the data units may be transmitted to the second host 2 from the first host 1.

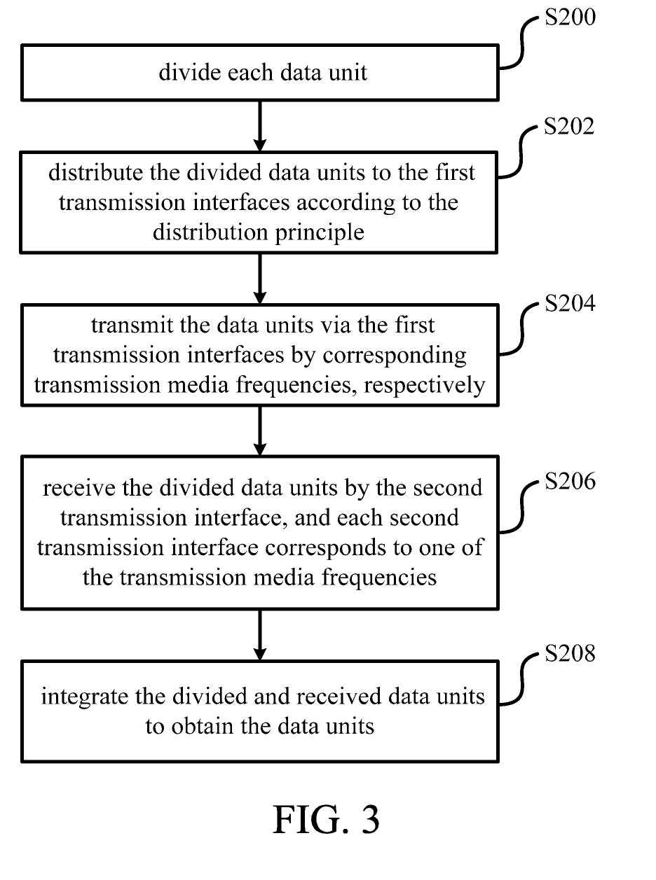

FIG. 3 is a flow chart showing a wireless transmission method according to a second preferred embodiment of the invention. As shown in FIG. 3, the wireless transmission method according to the second preferred embodiment of the invention is mainly used for transmitting a plurality of data units between the first host and the second host via the first wireless intermediary device and the second wireless intermediary device. The first wireless intermediary device includes a plurality of first transmission interfaces, and the second wireless intermediary device includes a plurality of second transmission interfaces. The wireless transmission method according to the second preferred embodiment of the invention may cooperate with the wireless transmission system 3 in FIG. 1 to be used. The detailed architecture of the wireless transmission system 3 is clearly illustrated above, and it is not described herein for a concise purpose. The wireless transmission method according to the second preferred embodiment of the invention mainly includes the following steps.

First, at step S200, each data unit is divided. Second, at step S202, the divided data units are distributed to the first transmission interfaces 302 according to the distribution principle. Third, at step S204, the data units are transmitted via the first transmission interfaces 302 by corresponding transmission media frequencies respectively. Fourth, at step S206, the divided data units are received by the second transmission interfaces 322, and each second transmission interface 322 corresponds to one of the transmission media frequencies. Finally, at step S208, the divided and received data units are integrated to obtain the data units.

The wireless transmission method according to the second preferred embodiment of the invention may be used when the sizes of the data units are very large, and the data units are first divided by the first host and transmitted to and integrated by the second host subsequently.

To sum up, the wireless intermediary device and the wireless transmission method according to the invention utilizes a plurality of wireless systems to increase the available bandwidth. Consequently, the transmission speed is higher, the transmission distance is longer, and multi-layer service application and high quality multimedia stream are provided.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A wireless intermediary device, used for transmitting a plurality of data units, the wireless intermediary device comprising:
a processing module; and
a plurality of transmission interfaces electrically connected with the processing module, respectively, to transmit the data units by corresponding transmission media frequencies;
wherein the processing module distributes the data units to the transmission interfaces according to a distribution principle to transmit the data units.

2. The wireless intermediary device according to claim 1, wherein the processing module further comprises:
a distribution unit electrically connected with the transmission interfaces, respectively, to distribute each of the data units to one of the transmission interfaces according to the distribution principle.

3. The wireless intermediary device according to claim 2, wherein the distribution principle is distributing the data units to the transmission interfaces averagely.

4. The wireless intermediary device according to claim 2, wherein the distribution principle is dynamically detecting a loading of the transmission interfaces and dynamically distributing each of the data units to the transmission interface according to the loading.

5. The wireless intermediary device according to claim 1, wherein the processing module further comprises:
a distribution unit electrically connected with the transmission interfaces, respectively, to divide each of the data units according to the distribution principle and distribute the divided data units to the transmission interfaces.

6. The wireless intermediary device according to claim 1, wherein the transmission media frequencies are orderly distributed at regular intervals.

7. The wireless intermediary device according to claim 1, wherein each of the transmission interfaces is a wireless network card.

8. A wireless transmission method, used for transmitting a plurality of data units between a first host and a second host via a first wireless intermediary device and a second wireless intermediary device, wherein the first wireless intermediary device includes a plurality of first transmission interfaces, and the second wireless intermediary device includes a plurality of second transmission interfaces, the wireless transmission method comprising:
distributing the data units to the first transmission interfaces according to a distribution principle;
transmitting the data units via the first transmission interfaces by corresponding transmission media frequencies, respectively; and
receiving the data units via the second transmission interfaces, wherein each of the second transmission interfaces corresponds to one of the transmission media frequencies.

9. The wireless transmission method according to claim 8, wherein the distribution principle is distributing the data units to the first transmission interfaces averagely.

10. The wireless transmission method according to claim 8, wherein the distribution principle is dynamically detecting a loading of the first transmission interface and the second transmission interface and dynamically distributing the data units to the transmission interfaces according to the loading.

11. The wireless transmission method according to claim 8, wherein at least one of the data units is generated from an application program executed in the first host, and the distribution principle is determining the first transmission interface by the application program for transmitting the at least one of the data unit.

12. The wireless transmission method according to claim 8, wherein the step of distributing the data units to the first transmission interfaces according to a distribution principle comprises:
dividing each of the data units; and
distributing the divided data units to the first transmission interfaces according to the distribution principle.

13. The wireless transmission method according to claim 12, wherein the step of receiving the data units via the second transmission interfaces comprises:
receiving the divided data units via the second transmission interfaces; and
integrating the divided and received data units to obtain the data units.

14. The wireless transmission method according to claim 8, wherein the first wireless intermediary device and the second wireless intermediary device are wireless access points.

15. The wireless transmission method according to claim 8, wherein the first wireless intermediary device and the second wireless intermediary device are routers.

16. The wireless transmission method according to claim 8, wherein each of the first transmission interfaces and each of the second transmission interfaces are wireless network cards.

17. The wireless transmission method according to claim 8, wherein the transmission media frequencies are orderly distributed at regular intervals.
